(19) United States
(12) Patent Application Publication
(10) Pub. No.: US 2008/0247322 A1
(43) Pub. Date: Oct. 9, 2008

(54) METHOD FOR MONITORING THE TRANSMISSION QUALITY OF CONNECTIONS IN MPLS NETWORKS

(75) Inventor: Joachim Klink, Muenchen (DE)

Correspondence Address: BELL, BOYD & LLOYD, LLP, P.O. BOX 1135, CHICAGO, IL, 60690, US

(73) Assignee: Siemens Aktiengesellschaft, Muenchen (DE)

(21) Appl. No.: 12/137,310

(22) Filed: Jun. 11, 2008

Related U.S. Application Data
(63) Continuation of application No. 10/513,346, filed on Oct. 28, 2004.

(30) Foreign Application Priority Data
Apr. 29, 2002 (DE) 102 19 152.2

(51) Int. Cl. H04L 12/26; H04L 12/56

(52) U.S. Cl. 370/241.1; 370/389

(57) ABSTRACT

The invention relates to a low-effort monitoring method of the transmission quality of connections in MPLS networks. Specially configured MPLS-OAM packets (MPLS-OAM-LAV packets) are defined and are periodically inserted into the traffic flow of user data packets at the source of a connection or a partial section of a connection, said MPLS-OAM-LAV packets being distinguishable from other MPLS-OAM packets and the MPLS packets carrying user data by a special mark. The information part of the MPLS-OAM-LAV packets contains a field receiving the number of MPLS packets that have been sent within a given period of time. Said tally is read out at the reception end (acceptor) and is compared with the number of actual packets received for said connection within the given period of time. The result serves as a criterion for lost and/or erroneously added packets.

### CROSS REFERENCE TO RELATED APPLICATIONS

This application is the US National Stage of International Application No. PCT/DE03/01336, filed Apr. 24, 2003 and claims the benefit thereof. The International Application claims the benefits of German application No. 10219152.2 DE filed Apr. 29, 2002, both of the applications are incorporated by reference herein in their entirety.

### FIELD OF INVENTION

The invention relates to a method in accordance with the Claims

### BACKGROUND OF INVENTION

In the prior art OAM (Operation and Maintenance) functionality is to be seen as a significant element of the operation of public communications networks. It supports the quality of the network performance while simultaneously reducing the operating costs of the networks. It makes a significant contribution, especially with regard to the Quality of Service (QoS) of the information transmitted. Strategies in respect of OAM functionalities have already been proposed for SONET/SDH as well as for ATM networks.

The OAM functionality allows the operator of a communications network to find out at any time whether the guaranteed quality-of-service levels (Service Level Agreement) for a connection are being adhered to. To be able to do this, the operator must also know the availability of existing connections (connection “up” or “down”), as well as the time delay for the transfer of the information (delay, delay variation), the—if necessary averaged—deviation from the otherwise normal gap between two information transfers (delay jitter) or the number of items of information not even allowed to be transferred (blocking rate, error).

If for example a connection fails, the fault must be determined immediately (fault detection), localized (fault localization) and the connection must also be able where necessary to be diverted to a standby route (protection switching). This enables both the traffic flow and the billing procedures in the network to be improved. MPLS networks are currently proposed for transmissions of information in the Internet. In MPLS (Multiprotocol Label Switching) networks information is transmitted by means of MPLS packets. MPLS packets are of variable length and each feature a header part and an information part. The header part is used to accommodate the connection information whereas the information part serves to accommodate payload information. IP packets are used as payload information. The connection information contained in the header part is embodied as an MPLS connection number. This number is only valid in the MPLS network however. This means that when an IP packet from an Internet network penetrates into the MPLS network (FIG. 1), this packet will be prefixed with the header part valid in the MPLS network. This header contains all the connection information which specifies the route of the MPLS packet in the MPLS network. If the MPLS packet leaves the MPLS network, the header part is removed again and the IP packet is routed onwards in the subsequent Internet network in accordance with the IP protocol. MPLS packets are transmitted unidirectionally.

FIG. 1 starts off from the typical assumption that information will for example be routed from a subscriber TLN1 to a subscriber TLN2. The sending subscriber TLN1 is connected in this case to the Internet network IP through which the information is routed in accordance with an Internet protocol, such as the IP protocol. This protocol is not a connection-oriented protocol The Internet network IP features a plurality of routers R which can be intermeshed. The receiving subscriber TLN2 is connected to a further Internet network IP. An MPLS network is inserted between the two Internet networks IP, through which packet-oriented information is switched in the form of MPLS packets. This network also features a plurality of intermeshed routers. In an MPLS network these can be so-called Label Switched Routers (LSR).

In MPLS networks the guarantee of Quality of Service (QoS) assumes major significance. In this case knowledge of the packets which are lost or incorrectly inserted during transmission has an important role to play for the network provider (transmission quality, performance monitoring), since on the basis of this information they can provide users with the corresponding connections. However the prior art does not contribute in any way to resolving this problem.

### SUMMARY OF INVENTION

The object of the invention is to demonstrate a way in which information about packets lost or incorrectly inserted during transmission can be made available with minimal effort in MPLS networks.

The object of the invention is achieved by starting from the features specified in of the Claims by the identifying features.

Especially advantageous in the invention is the provision of specifically embodied. MPLS-OAM packets, which are inserted into the traffic stream of payload data packets. In addition to the mark or identification in the header identifying the packet as an MPLS OAM packet (to distinguish between the MPLS OAM packets and MPLS packets carrying payload data) a further identification is required. The packets defined in this way (identified below as MPLS-OAM-LAV packets) are used for performance monitoring of an MPLS connection (MPLS Label Switched Path) while in the Information part of the MPLS-OAM-LAV packet a field is provided to accept the number of the MPLS packets sent per interval of time. On the receive side (sink) this count value also transmitted is read out and compared to the number of packets actually received for this connection within the specified time interval, with the result acting as a criterion for lost and/or incorrectly inserted packets.

Advantageous developments of the invention are specified in the dependent Claims.

### BRIEF DESCRIPTION OF THE DRAWINGS

The invention will be explained below in more detail using an exemplary embodiment.

The diagrams show:

FIG. 1 the basic circumstances in an MPLS network

FIG. 2 an end-to-end connection between two subscribers

FIG. 3 the circumstances in the packet header and in the information part of an MPLS-OAM packet

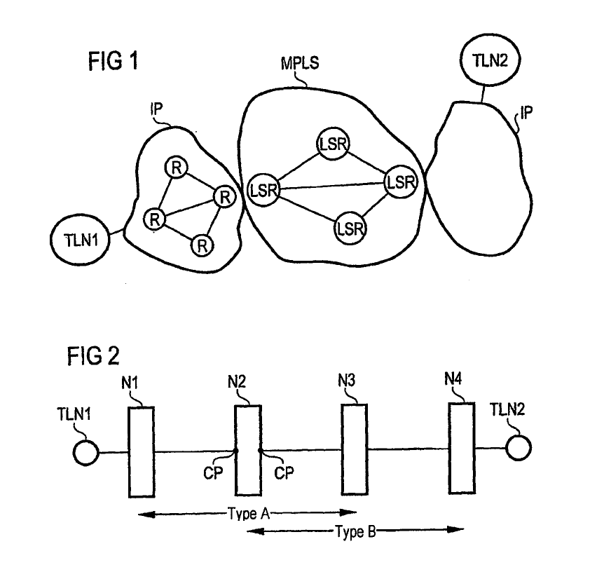

### DETAILED DESCRIPTION OF INVENTION

FIG. 2 shows a connection (Label Switched Path, LSP) between two subscribers TLN1, TLN2. This connection is routed via a plurality of nodes N1 . . . N4, which means that a plurality of connection hops (Label Switched Hop) are defined. The nodes N1 . . . N4 should be embodied as routers, LSRs of an MPLS network. After a successful connection setup information is now flowing between subscriber TLN1 and subscriber TLN2 comprising a plurality of MPLS packets carrying payload data information. MPLS-OAM packets can be inserted into this MPLS packet flow (Inband LSP). By contrast connections are defined via which exclusively MPLS-OAM packets are routed (Outband LSP). Basically inband MPLS-OAM packets are useful for logging LSP connections on an individual basis. In a number of cases it can be advantageous to define an out-of-band MPLS-OAM packet flow. One example of this is the MPLS group protection switching.

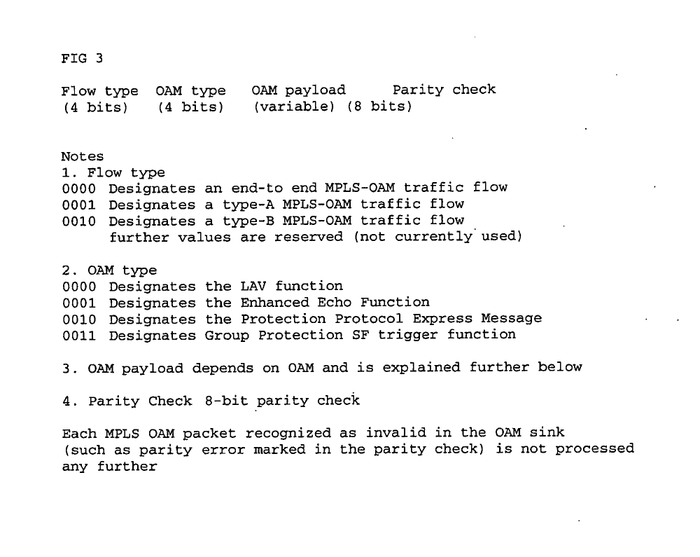

To be able to distinguish between MPLS-OAM packets and MPLS packets carrying payload data, the MPLS-OAM packets are marked. The special marking mechanisms are shown in FIG. 3 and are described later in greater detail. The sequence of a number of MPLS-OAM packets defines an MPLS-OAM packet flow. Basically 3 different types of MPLS-OAM packet flows can exist simultaneously for an LSP connection:

End-to-end MPLS-OAM packet flow. This is used in particular if there is OAM communication between a source and a sink of an LSP connection. It is formed from MPLS-OAM packets which are inserted into the payload data stream in the source of the LSP connection and are removed again at the sink. The MPLS-OAM packets can be recorded and monitored along the LSP connection at the Connection Point CP without the need for intervention into the transmission process (passive).

One of the end-to-end defined MPLS-OAM packet flows is the MPLS-OAM packet flow type A. It is used in particular if there is OAM communication between the nodes which delimit the type A connection segment (FIG. 2). One or more type-A MPLS-OAM segments can be defined in the LSP connection, but they can neither be interleaved nor can they overlap with other segments of type A.

Finally, of the two types of packet flow specified below, type-B MPLS-OAM packet flow is identified. It is used in particular if there is OAM communication between the nodes which delimit the type B connection segment (FIG. 2). One or more type-B MPLS-OAM segments can be defined in the LSP connection, but they can neither be interleaved nor can they overlap with other segments of type B.

Basically an MPLS-OAM packet flow (end-to-end, type A, type B) is made up of MPLS-OAM packets which are inserted at the start of the section into the payload data stream and removed from this stream again at the end of the segment. They can be recorded and processed along the LSP connection at the Connection Point CP without the need for intervention into the transmission process. Each Connection point CP in the LSP connection including the sources and sinks of the connection can be configured as MPLS-OAM source or MPLS-OAM sink, in which case the outgoing MPLS-OAM packets from an MPLS-OAM source are preferably to be configured as “upstream”.

Before MPLS-OAM packets (end-to-end, type A, type B) are transmitted over the MPLS network, the end points (source, sink) of the associated MPLS-OAM segment must be defined. The definition of source and sink for an MPLS-OAM segment is not necessarily set for the duration of the connection. This means for example that the segment involved can be reconfigured via fields in the signaling protocol.

For each LSP connection interleaving of the segmented MPLS-OAM-packet flow (type A or type B) within an end-to-end MPLS-OAM packet flow is possible. In this case the Connection Points CP can simultaneously be source/sink of a segment flow (type A or type B) and also of the end-to-end MPLS-OAM packet flow.

The MPLS-OAM packet flow (segment flow) of type A is functionally independent of that of type B with regard to the insertion, removal and the processing of the MPLS-OAM packets. In general it is thus possible to interleave type-B MPLS-OAM-packets with those of Type A and vice versa, in the case of interleaving a Connection point CP can thus also simultaneously be source and sink of an OAM segment flow of type A and of type B.

The overlapping of the type A segments with those of type B is possible depending on the network architecture. For example in the case of a point-to-point-network architectures segments of type A can overlap with those of type B. Both segments can operate independently and will thus not influence each other in any way. In MPLS protection switching however the overlapping can lead to problems.

The MPLS-OAM packets can be distinguished from MPLS packets carrying payload data by using one of the EXP bits in the MPLS packet header. This method in particular provides a very simple method of distinguishing between packets. This bit can be checked in the sink of an MPLS-OAM segment or at the Connection points CP to filter out MPLS-OAM packets before further evaluation is undertaken.

Alternatively one of the MPLS label values) No. 4 to No. 15 can be used as an identifier in the header part of the MPLS packet. These MPLS label values are reserved by the IANA. In this case the next identification in the stack of the assigned LSP connection must indicate what the OAM functionality is used for. This approach to a solution is rather more complex to implement since the hardware in the OAM sink and the Connection points CP needs two MPLS stack entries for each MPLS-OAM packet. Naturally processing must take place in real time, i.e. in the Connection Points CP the OAM packets must be inserted back into the flow while retaining the sequence. This is absolutely necessary to ensure correct performance monitoring results in the OAM sink.

For verification of the availability of an MPLS-LSP connection (referred to below as the MPLS-LAV function, MPLS-OAM-LAV packets are defined. They are inserted into the flow of the payload information (in-band flow) and are assigned to a specific LSP connection. Thus the availability of an LSP connection can be determined on an end-to-end basis or a segmented basis. For this purpose an MPLS-OAM-LAV packet is inserted periodically per time interval (e.g. per second) at the source and is monitored periodically per time interval (e.g. per second) at the sink for its arrival. If, after a predefined time (of a number of seconds for example) and if necessary multiple checks (e.g. 2 to 3 times) no MPLS-OAM-LAV packet has been received at the sink, the LSP connection is declared as not available (LSP=“down” or “unavailable”), in the case of the non-available LSP connection further periodic checks are made at the sink for the arrival of the MPLS-OAM-LAV packet, and if, after a predefined period (of several seconds) this is received at the sink again, the connection is declared as available again.

The MPLS-LAV function can be activated simultaneously on an end-to-end basis or segmented basis for each LSP connection at any interface CP or network element. Activation and deactivation is just as possible using signaling procedures as it is using manual configuration via network management. The feature can be activated at any time, that is either during connection setup or afterwards.

If a segment is monitored it is first necessary to define the limits of the segment involved with the assigned LSP connection. This is generally done by determining source and sink. After this the MPLS-LAV function can then be activated. It must however be inactive if the limits of a segment are to be changed or the segment is to be deleted, which is possible at any time.

The advantage of the MPLS-LAV function lies in its ability to check whether the quality of service parameters in the service level agreement of the LSP connection involved have also been adhered to. The availability status is especially of interest here, i.e. whether the LSP connection is available (LSP=“up” or “available”) or riot (LSP=“down” or “unavailable”). This allows the failure of an LSP connection (Signal Fail Situations) to be determined. In this case MPLS protection switching can be initiated or an alarm generated, which is forwarded to the network operator if necessary.

The availability status of the LSP connection (LSP=“available”, LSP=“unavailable”) is now taken as the basis for further information. Thus the availability status is an indication for the occurrence of the failure of a connection (Signal Fail Situation). In the case of non-availability a “Signal Fail” signal is activated, in the case of availability of the connection this signal is deactivated. With the aid of this signal protection switching requests (MPLS Protection Switching) or alarms can then be initiated. Furthermore the location of the underlying network fault can be determined as part of diagnostic measures.

As an additional function for the monitoring function (MPLS-LAV function) a further purely passive monitoring function (non-intrusive monitoring function) can be provided. With this function the MPLS-OAM-LAV packets are only read during the monitoring procedure but are not modified (non-intrusive). They can be determined at each of the Connection Points CP along the MPLS-OAM-LAV traffic flow on an end-to-end basis or segment basis by the content of the MPLS-OAM-LAV packets passing the Connection Point CP being processed without characteristic values such as the content of the packets for example being changed. Monitoring is also undertaken end-to-end, i.e. in this case individual connection segments of the overall connection are checked. In this case passive monitoring includes that same functionality as that described for the MPLS-LAV function.

The advantage of the passive monitoring function is to be seen in fault localization. With this a step-by-step method can be implemented which allows the parts of the LSP connection which are interrupted to be determined. The signal degrade can thus be determined.

The MPLS-LAV function further forms the basis for monitoring the transmission quality (performance monitoring). In this case the function which monitors the transmission quality (called the PM function below), is to be seen as a subfunction of the MPLS-LAV function.

The function is used to monitor the transmission quality of a connection on an end-to-end basis or a segment basis. In this case the number of MPLS-LAV packets which are lost per interval of time during transmission plays as great a role as the number of packets inserted incorrectly. An interval of 1 second can be used as a time interval for example (one-second interval). For this purpose the MPLS-OAM-LAV package contains a special field for accommodating a packet counter.

Transmission quality is now monitored by initially counting in the source the number of MPLS packets carrying payload data sent which are transmitted per second for the LSP connection involved. The value determined in this way is transmitted to the sink where it is compared to the status of a further counter, in which the number of MPLS packets carrying payload data which have arrived at the sink is recorded. By comparing the two values the number of packets lost during the transmission or the packets incorrectly inserted can be determined.

The PM function can only be activated if the (associated) MPLS-LAV function is active. If this is the case for a specific LSP connection the function can be active or inactive depending on requirements. The PM function can also be activated and deactivated using signaling procedures as it can be alternatively by manual configuration.

The PM function is used to determine and whether negotiated (Service Level Agreement), guaranteed quality of service (QoS) of the assigned LSP connection has also been maintained. This includes for example the requirements with regard to a error performance. Furthermore it can be determined whether the throughput guaranteed for the connection has actually been maintained by a network

The PM function can also be used to identify it the degradation of a signal (Signal Degrade) for an LSP connection. In this case MPLS protection switching can be initiated as a result. As an alternative alarm can also be generated which is routed to the network operator for example. As a further application MPLS Traffic Engineering can be provided to enable overload situations in the network to be determined.

When the PM function is active a free running at counter in the sauce counts the number of MPLS Packets carrying payload data which were sent for a corresponding LSP connection. In this case MPLS packets carrying payload data are taken to mean all packets which are not marked as OAM packets. The counter can for example be embodied as a 16-bit counter (free running, modulo 65536). Each time that an MPLS packet is inserted into the MPLS traffic flow of the LSP connection involved (e.g. per second) the current value of the counter is written into the corresponding field of the MPLS LAV packet. This means that on the send side (Source) the difference between two consecutive counter states corresponds to the number of MPLS packets carrying payload data which have been transmitted between two MPLS-OAM-LAV packets transmitted immediately after one another.

When the function is active a further free running counter in the sink counts the number of MPLS packets carrying a payload data which arrive (for this LSP connection). This counter is also embodied as a 16-bit counter (free-running, modulo 65536). Each time that an MPLS-OAM-LAV packet is received for the relevant LSP connection (e.g. per second), the following calculations are made in real-time processing (i.e. within the transmission time of an MPLS packet carrying the payload data):

Initially in the first calculation step the difference is formed between the current counter status (after determining of the number of MPLS packets arriving) and the counter status shown by this counter on evaluation of the last MPLS-OAM-LAV packet. The result corresponds to the number of MPLS packets carrying payload data which arrived during the one-second interval for this LSP connection.

This is then followed in a second calculation step by reading at the counter status transmitted as well in the MPLS-OAM-LAV packet, and subtracting it from the value of the MPLS-OAM-LAV packet which arrived previously. The result corresponds to the number of MPLS packets carrying user data which have been sent in the source for this LSP connection.

The difference between two calculations corresponds to the number of packets lost during the last one-second interval for the LSP connection involved (assuming that more packets were sent than were received). This result will be stored for this time interval. If more packets have arrived than were sent it is assumed that packets were incorrectly inserted somewhere into this LSP connection during the transmission. A free-running one-second counter in the sink then initiates further processing.

If the status of the associated LSP connection is “down” or “unavailable” activation of the PM function is suppressed until the status of this connection is again “up” or “available.

If the information contained in an MPLS-OAM-LAV packet regarding the PM function is lost no major problems should be expected. The packet received next with information and relating it to the PM is then simply evaluated and the result is applied to the two-second interval.

With a 16-bit counter—as described above—connections with a throughput of 10 Gbit/sec (corresponding to approximately 300 million IP packets per second) and packets losses can be precisely calculated to at least the power of 10-4. This assumes IP packets with the smallest possible size. For higher packet losses the results can be more imprecise in which case it is however likely that under these circumstances the connection will be interrupted (Signal Fail) and declared as unavailable in which case the performance monitoring results are invalid in any event.

If both the loss and also the incorrect insertion of packets of occurs directly consecutively the results will partly balance each other out. It can however be assumed here that this does not represent a usual situation in normal operation.

The results as regards the loss rates or incorrect insertion of packets per one-second interval are taken as a basis for further calculations:

It is thus possible with this information to determine whether a signal degrade situation has occurred. If this is the case MPLS protection switching can be initiated for example. Furthermore the results for a one-second interval can be accumulated into a 15-minute interval. This enables the appropriate statements to be made for a 15-minute interval. These are stored and if necessary directed to network management. Further intervals such as for example 24-hour intervals are also possible.

Further the transmission quality of the connection or of a segment of the connection can be monitored in any network equipment lying between the source and the sink. With

the information about the transmission quality of the MPLS connection in any MPLS network equipment lying between the source and the sink it is also possible to locate the underlying network faults within the framework of diagnostic measures.

1.-7. (canceled)

8. A method for connection-oriented transmission of variable-length packets over a connection, the connection including a plurality of connection sections, comprising:
marking some of the packets;
supplying an identifier and a count value to some of the marked packets;
entering a number of transmitted packets within a specified time interval into the count value, the count value entered at a sending side;
receiving the count value;
comparing the count value with a number of packets actually received for the connection within the specified time interval; and
using the compared results as a criterion for transmission discrepancies, the transmission discrepancies selected from the group consisting of lost packets, inserted packets, and a combination thereof,
wherein a link is selected from the group consisting of the connection and connection sections.

9. The method as claimed in claim 8, wherein the variable-length packets are transmitted via a multiprotocol label switching method.

10. The method as claimed in claim 9, wherein the variable-length packets are MPLS packets, the marked packets are MPLS OAM packets, and the MPLS OAM packets including the identifier are MPLS OAM LAV packets.

11. The method as claimed in claim 10, wherein the MPLS network is monitored via the MPLS-OAM-LAV packet, the MPLS-OAM-LAV packets are marked as a segment MPLS-OAM traffic flow and the MPLS-OAM-LAV packets are transmitted in the connection segment that is identified as an OAM segment.

12. The method as claimed in claim 10, wherein an alarm indicating that a transmission quality is adversely effected is generated and forwarded to a handler selected from the group consisting of network operator, MPLS protection switching procedure and combinations thereof, when a number of the transmission discrepancies of the link exceeds a present threshold value.

13. The method as claimed in claim 12, wherein information of the transmission quality being adversely effected is forwarded to a network management system where the information is processed and stored to provide a network operator with transmission quality statistics of the link.

14. The method as claimed in claim 8, wherein a transmission quality of the link is monitored in any network equipment lying between a source and a sink

15. The method as claimed in claim 14, wherein a network control is selected from the group consisting of a network signaling and network management.

16. The method as claimed in claim 15, wherein a monitoring of the transmission quality of the link can be activated at the source and the sink by control sequences initiated via a network control.

17. The method as claimed in claim 15, wherein a monitoring of the transmission quality of the link can be deactivated at the source and the sink by control sequences initiated via a network control.

18. A multiprotocol label switching network, comprising:
a connection maintained over a plurality of nodes implemented as label switched routers, the connection including a connection section;
a plurality of variable length MPLS packets;
a mark included in some of the MPLS packets;
an indicator included in some of the marked MPLS packets;
a send count value containing a count of the MPLS packets transmitted within a specified time interval, the count value included in some of the MPLS packets; and
a receive count value containing the actual number of MPLS packets received, a transmission discrepancy detected by comparing the send count value in a received MPLS packet with the receive count value,
wherein the transmission discrepancy is selected from the group consisting of lost MPLS packets, inserted MPLS packets and a combination thereof,
wherein a link is selected from the group consisting of the connection and connection sections.

19. The network as claimed in claim 18, wherein an alarm indicating that a transmission quality is adversely effected is generated and forwarded to a handler selected from the group consisting of network operator, MPLS protection switching procedure and combinations thereof, when a number of the transmission discrepancies of the link exceeds a present threshold value.

20. The network as claimed in claim 18, wherein transmission quality information is forwarded to a network management system providing transmission quality statistics of the link.

21. The network as claimed in claim 18, wherein a transmission quality of the link is monitored by a sink.

22. The network as claimed in claim 18, wherein a transmission quality of the link is monitored by a source.

23. The network as claimed in claim 18, wherein a transmission quality of the link is monitored by network equipment between a sink and a source.

24. The network as claimed in claim 18, wherein monitoring the transmission quality of the link may be activated.

25. The network as claimed in claim 18, wherein monitoring the transmission quality of the link may be deactivated.
